(19) United States
(12) Patent Application Publication
(10) Pub. No.: US 2024/0157182 A1
(43) Pub. Date: May 16, 2024

(54) FIRE EXTINGUISHING DEVICE FOR ELECTRIC VEHICLE BATTERIES

(71) Applicant: INDUSTRY-ACADEMIC COOPERATION FOUNDATION, KUNSAN NATIONAL UNIVERSITY, Jeollabuk-do (KR)

(72) Inventor: HIE CHAN KANG, Jeollabuk-do (KR)

(21) Appl. No.: 18/388,900

(22) Filed: Nov. 13, 2023

(30) Foreign Application Priority Data
Nov. 14, 2022 (KR) 10-2022-0151423

(51) Int. Cl. A62C 3/07

(52) U.S. Cl. CPC A62C 3/07

(57) ABSTRACT

A fire extinguishing device for an electric or hydrogen vehicle battery is configured to directly spray a fire extinguishing liquid between a battery module and a housing covering the battery module, in an event of a fire in the battery module of the electric or hydrogen vehicle, thereby improving fire suppression efficiency. The fire extinguishing device may include a fire extinguishing liquid inlet and a fire extinguishing liquid outlet formed in the battery housing, and a connection hose having a side connected to the fire extinguishing liquid inlet and an opposite side connected to a vehicle body.

### CROSS-REFERENCE TO RELATED APPLICATION AND CLAIM OF PRIORITY

This application claims the benefit under 35 USC § 119 of Korean Patent Application No. 10-2022-0151423, filed on Nov. 14, 2022, in the Korean Intellectual Property Office, the entire disclosure of which is incorporated herein by reference for all purposes.

### BACKGROUND

### 1 Technical Field

The present disclosure relates to a fire extinguishing device for electric or hydrogen vehicle batteries, and more particularly, to a fire extinguishing device for electric or hydrogen vehicle batteries with improved structure to suppress a fire by a direct fire extinguishing method of injecting a fire extinguishing liquid into a battery housing that covers a battery module, rather than an indirect fire extinguishing method of spraying a fire extinguishing liquid outside of the housing, in the event of the fire in the electric vehicle battery.

The research on this invention was supported by Korea Basic Science Institute (National research Facilities and Equipment Center) grant funded by the Ministry of Education. (2023R1A6C101B042)

### 2. BACKGROUND ART

Electric vehicle sales worldwide soared to about 6,600,000 units in 2021. With the widespread use of electric vehicles, battery fire frequencies are increasing.

In particular, it is difficult to suppress battery fires in electric vehicles due to thermal runaway. There are various fire extinguishing methods, for example, a water-based fire extinguishing agent, a suffocation cover and a portable water storage, but when a fire occurs in a battery housing, the fire is suppressed by the fed fire extinguishing liquid outside of the battery housing, so it takes a large amount of fire extinguishing liquids and a long time to suppress the fire and it is unable to suppress the fire quickly, causing a large amount of toxic gases and battery overheating, resulting in explosions and fire spread to nearby battery modules and nearby vehicles, and in the case where the fire occurs in an underground parking lot, in reality, it is difficult to suppress the fire.

### SUMMARY

The present disclosure is designed to solve the above-described problem, and therefore the present disclosure is directed to providing a fire extinguishing device for electric or hydrogen vehicle batteries for forcibly injecting a fire extinguishing liquid into an electric vehicle battery in the event of a fire in the battery.

The present disclosure is further directed to providing a fire extinguishing device for electric vehicle batteries for minimizing interferences between components in a narrow space inside a vehicle body in the design of a structure for directly injecting a fire extinguishing liquid into a battery housing that protects a battery module.

To achieve the above-described objective, a fire extinguishing device for electric or hydrogen vehicle batteries according to the present disclosure is configured to directly spray a fire extinguishing liquid between a battery module and a battery housing in an event of a fire in a battery of an electric vehicle or a hydrogen vehicle, thereby improving fire suppression efficiency, and includes a fire extinguishing liquid inlet and a fire extinguishing liquid outlet formed in the battery housing; and a connection hose having a side connected to the fire extinguishing liquid inlet and an opposite side connected to a vehicle body.

The present disclosure preferably further includes a valve installed at each of the fire extinguishing liquid inlet and the fire extinguishing liquid outlet, and configured to selectively inject the fire extinguishing liquid, and in a normal situation, to prevent external moisture from entering the battery housing.

The valves are preferably a pressure actuated valve that operates by a pressure.

The pressure actuated valve preferably operates under an absolute pressure of 150 kPa or above.

The present disclosure preferably further includes a connection coupling having a side exposed to outside of the vehicle body for connection of a fire extinguishing liquid supply nozzle, and an opposite side in communication with the connection hose connected to the vehicle body.

The connection coupling corresponds to a portion of the vehicle body, and is preferably installed at a charging frame having a charging port of the electric vehicle.

The connection hose may include a bellows-shaped portion that can extend and retract, causing a length change.

The present disclosure may include a receiving unit disposed inside of the vehicle body to receive the connection hose, wherein the receiving unit includes a first receiving housing installed inside the vehicle body and having a receiving space, a second receiving housing that forms the receiving space with the first receiving housing, and engaged with the first receiving housing to prevent a portion of the connection hose received in the receiving space in a zigzag from slipping out of place, and a disengagement portion disposed on the opposite side of the connection coupling, and configured to apply an applied external pressure to the second receiving housing to disengage the second receiving housing from the first receiving housing so that the second receiving housing is separated from the first receiving housing.

The present disclosure may include a pair of stopper protrusions formed on a pair of opposite surfaces that form the receiving space of the first receiving housing, spaced apart from each other; and an interlock protrusion formed on a surface of the second receiving housing facing the pair of opposite surfaces, and inserted into the pair of stopper protrusions, wherein before the external pressure is applied to the connection coupling, the interlock protrusion is kept inserted into the pair of stopper protrusions to fix a relative position of the second receiving housing to the first receiving housing, and upon the application of the external pressure to the connection coupling, the interlock protrusion is disengaged from the pair of stopper protrusions to separate the second receiving housing from the first receiving housing, and at the same time, the disengagement portion of the connection coupling is inserted between the pair of stopper protrusions to connect a connection pipe for injection of the fire extinguishing liquid to the connection coupling outside of the vehicle body.

The fire extinguishing device for electric vehicle batteries having the above-described configuration according to the present disclosure is configured to forcibly inject a fire extinguishing liquid into the battery housing installed in the vehicle body outside of the vehicle body, to significantly reduce the time required to suppress thermal runaway that occurs in the event of a fire in an electric vehicle, thereby preventing chain explosion in the battery module and consequential fire spread, and to suppress the fire quickly using a small amount of fire extinguishing liquids, thereby improving the fire extinguishing liquid use efficiency and fire suppression efficiency, and in particular, to prevent fire propagation in environments in which electric vehicles are densely populated such as underground parking lots.

### BRIEF DESCRIPTION OF THE DRAWINGS

FIG. 1 is an installation diagram showing a fire extinguishing device for electric or hydrogen vehicle batteries according to an embodiment of the present disclosure.

FIG. 2 is a perspective view showing a battery module that is a target for fire suppression according to an embodiment of the present disclosure.

FIG. 3 is a diagram illustrating a flow of a fire extinguishing liquid of an embodiment of the present disclosure.

FIG. 4 is a diagram illustrating the structure of a connection hose used in another embodiment of the present disclosure.

FIG. 5 is a cross-sectional view illustrating a connection hose receiving unit used in another embodiment of the present disclosure.

FIG. 6 is a diagram illustrating the operation and function of a connection hose receiving unit used in another embodiment of the present disclosure.

### DETAILED DESCRIPTION

In the following description, to clarify the understanding of the present disclosure, description of known technology relating to the feature of the present disclosure is omitted. The following embodiment provides a detailed description to help the understanding of the present disclosure, and obviously, is not intended to limit the scope of protection of the present disclosure. Therefore, the equivalent invention that performs the same functions as the present disclosure will fall in the scope of protection of the present disclosure.

In addition, in the following description, the same reference sign denotes the same element, and any unnecessary redundant description and description of known technology is omitted. Additionally, the following description of each embodiment of the present disclosure overlapping the description of the background art is also omitted.

Hereinafter, a fire extinguishing device for electric or hydrogen vehicle batteries according to an embodiment of the present disclosure will be described in detail with reference to the accompanying drawings.

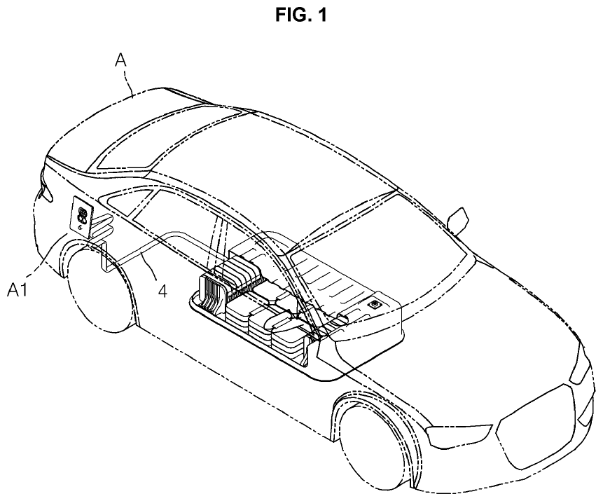

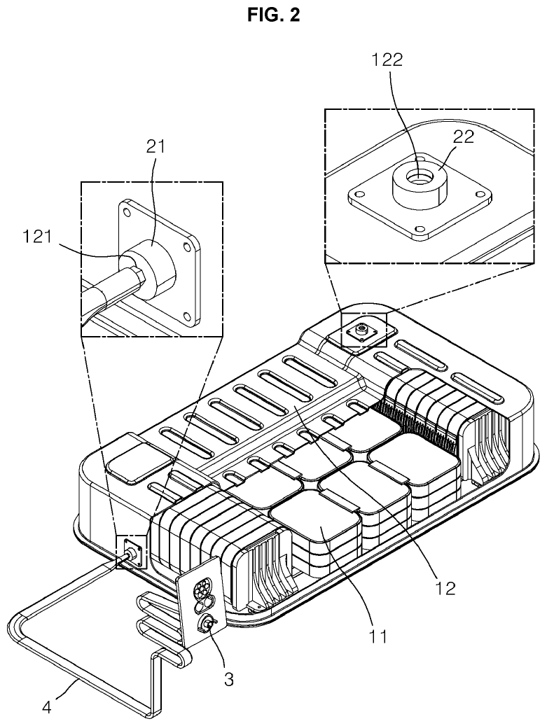

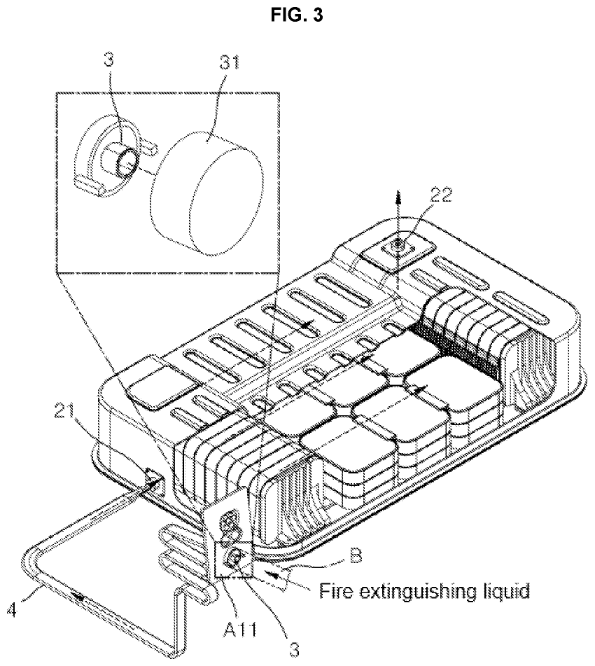

FIG. 1 is an installation diagram showing the fire extinguishing device for electric or hydrogen vehicle batteries according to an embodiment of the present disclosure, FIG. 2 is a perspective view showing a battery module that is a target for fire suppression according to an embodiment of the present disclosure, and FIG. 3 is a diagram illustrating a flow of a fire extinguishing liquid of an embodiment of the present disclosure.

As shown in FIGS. 1 to 3, the fire extinguishing device for electric or hydrogen vehicle batteries according to an embodiment of the present disclosure is configured to directly spray a fire extinguishing liquid between a battery module and a housing 12 covering the battery module 11, which constitute a battery module 1, in the event of a fire in the battery module 1 of the electric or hydrogen vehicle, thereby improving fire suppression efficiency, and includes a fire extinguishing liquid inlet 121 and a fire extinguishing liquid outlet 122, valves 21, 22, a connection coupling 3 and a connection hose 4.

Each of the fire extinguishing liquid inlet 121 and the fire extinguishing liquid outlet 122 is formed in the battery housing 12, and plays a role in communicating the inside of the battery housing 12 with the outside.

In this embodiment, to prevent sealability damage that occurs due to the fire extinguishing liquid inlet 121 and the fire extinguishing liquid outlet 122 formed in the battery housing 12, the valves 21, 22 are installed at the fire extinguishing liquid inlet 121 and the fire extinguishing liquid outlet 122, respectively.

The valves 21, 22 selectively open/close the fire extinguishing liquid inlet and the fire extinguishing liquid outlet 122. In a normal situation, the valves 21, 22 perform the closing operation to prevent external air and moisture from entering the battery housing 12, and in the event of fire, perform the opening operation by the injection pressure of the fire extinguishing liquid, thereby allowing for selective injection of the fire extinguishing liquid.

The valves 21, 22 may include a variety of valves that selectively open/close the fire extinguishing liquid inlet 121 and the fire extinguishing liquid outlet 122, but it is preferred to use a pressure actuated valve that performs the opening/closing operation by the injection pressure of the fire extinguishing liquid.

The pressure actuated valve may include, for example, a rupture valve which is one of pressure reducing valves, and preferably operates under the absolute pressure of 150 kPa or more to prevent damage to sealability of the battery housing 12 that occurs due to being open by an arbitrary pressure.

The connection coupling 3 may have one side exposed to the outside of a vehicle body A for connection of a fire extinguishing liquid supply nozzle, and the other side in communication with the inside of the vehicle body A. The connection coupling 3 may have various shapes and structures for connection of a tubular connection pipe B in which a fluid flows.

Additionally, the connection coupling 3 may be installed at different locations of the vehicle body A, but is preferably installed at a charging frame A11 on a rear fender of the vehicle body A to charge the electric vehicle without changing the vehicle body A structure of the electric vehicle. The charging frame A11 has a charging port to which a charging terminal is connected.

In this embodiment, as best shown in FIG. 3, a cover 31 is preferably installed in the vehicle body outside of the connection coupling 3, and in the event of fire, the cover 31 preferably can be easily broken down to inject the fire extinguishing liquid through the connection coupling 3.

Here, the cover 31 acts as an emergency bell cover of a fireplug. In a normal situation, the cover 31 covers the connection coupling 3 to prevent the exposure of the connection coupling 3 for aesthetic purposes, and in the event of fire, allows firefighters or first responders to the fire to easily destroy it to inject the fire extinguishing liquid or water in order to extinguish the fire.

The connection hose 4 connects the fire extinguishing liquid inlet 121 on the side of the battery housing 12 inside of the vehicle body A to the connection coupling 3 outside of the vehicle body A to allow for a fluid to move, in order to forcibly feed the fire extinguishing liquid into the battery housing 12.

The fire extinguishing device for electric vehicle batteries having the above-described configuration according to an embodiment of the present disclosure is configured to forcibly inject the fire extinguishing liquid into the battery housing 12 installed in the vehicle body A outside of the vehicle body A, to significantly reduce the time required to suppress thermal runaway that occurs in the event of a fire in an electric vehicle, thereby preventing chain explosion in the battery module 1 and consequential fire spread, and to suppress the fire quickly using a small amount of fire extinguishing liquids, thereby improving fire extinguishing liquid use efficiency and fire suppression efficiency, and in particular, to prevent fire propagation in environments in which electric vehicles are densely populated such as underground parking lots.

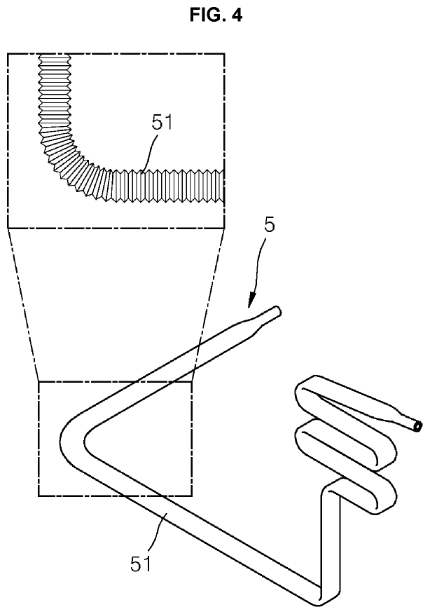

Hereinafter, various embodiments of the present disclosure will be described in detail with reference to FIGS. 4 to 6.

FIG. 4 is a diagram illustrating the structure of the connection hose used in another embodiment of the present disclosure.

The connection hose 5 used in this embodiment includes a bellows-shaped portion 51 that can extend and retract, causing a length change, and in a normal situation, is configured to be compactly placed in the vehicle body, thereby minimizing interferences between components in the narrow space inside the vehicle body, and in the event of fire, be extended by the injection pressure of the fire extinguishing liquid to reduce the fluid flow resistance that occurs in a short pipe structure, thereby achieving smooth injection of the fire extinguishing liquid.

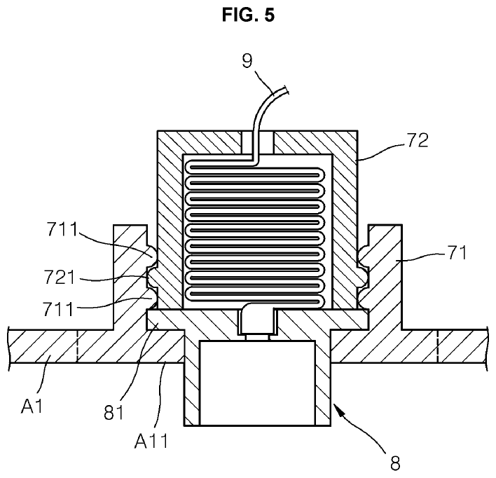

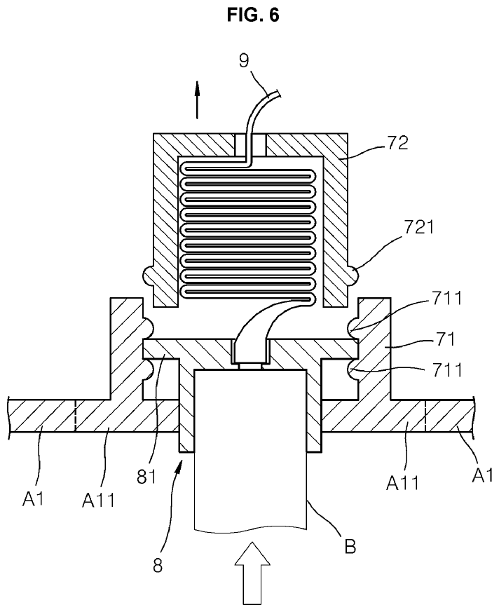

FIG. 5 is a cross-sectional view illustrating a connection hose receiving unit used in another embodiment of the present disclosure, and FIG. 6 is a diagram illustrating the operation and function of the connection hose receiving unit used in another embodiment of the present disclosure.

In addition to the above-described configuration, this embodiment may further include the receiving unit disposed within the vehicle body A to receive the connection hose 9.

The receiving unit may be formed with various structures, but in this embodiment, includes a first receiving housing 71 and a second receiving housing that are separably combined with each other, and a disengagement portion 81 to selectively separate the second receiving housing 72 from the first receiving housing 71.

The first receiving housing 71 is installed inside the vehicle body A and has a receiving space. The second receiving housing 72 forms the receiving space with the first receiving housing 71, and is engaged with the first receiving housing such that it is separably connected to the first receiving housing 71, in order to prevent a portion of the connection hose 9 received in the receiving space in a zigzag from slipping out of place.

The disengagement portion 81 is disposed on the other side of the connection coupling 8 installed in the charging frame A11, and in the event of fire, applies the external pressure to the second receiving housing 72 to disengage the second receiving housing 72 from the first receiving housing 71 so that the second receiving housing 72 is separated from the first receiving housing 71.

In this embodiment having the above-described configuration, as shown in FIG. 5, in a normal situation in which a fire did not occur, a portion of the connection hose 9 is stored folded in a zigzag in the receiving space of the first receiving housing 71 and the second receiving housing 72, to prevent interferences between the connection hose 9 and other components in the narrow space inside the vehicle body A, and in the event of fire, as shown in FIG. 6, the pressure is applied to the connection coupling 8 to allow the disengagement portion 81 of the connection coupling 8 to separate the second receiving housing 72 from the first receiving housing 71 in order to unfold the connection hose 9 folded in a zigzag, thereby injecting the fire extinguishing liquid into the battery housing quickly and smoothly.

Additionally, this embodiment includes a pair of stopper protrusions 711 of the first receiving housing 71 and an interlock protrusion 721 of the second receiving housing 72.

The pair of stopper protrusions 711 are formed on a pair of opposite surfaces that form the receiving space of the first receiving housing 71 and spaced apart from each other, and the interlock protrusion 721 is formed on a surface of the second receiving housing 72 facing the pair of opposite surfaces and inserted into the pair of stopper protrusions 711.

In this embodiment having the above-described configuration, before the external pressure is applied to the connection coupling 8, the interlock protrusion is kept inserted into the pair of stopper protrusions 711 to fix the relative position of the second receiving housing 72 to the first receiving housing 71, and when the external pressure is applied to the connection coupling 8, the interlock protrusion 721 is disengaged from the pair of stopper protrusions 711 to separate the second receiving housing 72 from the first receiving housing 71, and at the same time, the disengagement portion of the connection coupling 8 is inserted between the pair of stopper protrusions 711 to connect the connection pipe for injection of the fire extinguishing liquid to the connection coupling 8 outside of the vehicle body A.

While various embodiments of the present disclosure have been hereinabove described, the embodiment and the accompanying drawings clearly represent a portion of the technical subject matter included in the present disclosure, and it is obvious that the scope of protection of the present disclosure encompasses variations and specific embodiments that may be easily inferred by those skilled in the art within the scope and technical spirit included in the specification and drawings of the present disclosure.

What is claimed is:

1. A fire extinguishing device for an electric or hydrogen vehicle battery, comprising:
a battery housing;
a fire extinguishing liquid inlet and a fire extinguishing liquid outlet formed in the battery housing; and
a connection hose having a side connected to the fire extinguishing liquid inlet and an opposite side configured to be connected to a vehicle body,
wherein the fire extinguishing device is configured to directly spray a fire extinguishing liquid between a battery module and a housing covering the battery module of an electric or hydrogen vehicle, in an event of a fire in the battery module.

2. The fire extinguishing device of claim 1, further comprising:
a valve installed at each of the fire extinguishing liquid inlet and the fire extinguishing liquid outlet, and configured to selectively inject the fire extinguishing liquid, and in a normal situation, to prevent external moisture from entering the battery housing.

3. The fire extinguishing device of claim 2, wherein the valve is a pressure actuated valve configured to operate by a pressure.

4. The fire extinguishing device of claim 3, wherein the pressure actuated valve is configured to operate under an absolute pressure of 150 kPa or above.

5. The fire extinguishing device of claim 1, further comprising:
a connection coupling having a side exposed to outside of the vehicle body for connection of a fire extinguishing liquid supply nozzle, and an opposite side in communication with the connection hose connected to the vehicle body.

6. The fire extinguishing device of claim 5, wherein the connection coupling corresponds to a portion of the vehicle body, and is installed at a charging frame having a charging port of the electric vehicle.

7. The fire extinguishing device of claim 1, wherein the connection hose includes a bellows-shaped portion that can extend and retract, causing a length change.

8. The fire extinguishing device of claim 1, comprising:
a receiving unit disposed inside of the vehicle body to receive the connection hose, the receiving unit comprising:
a first receiving housing installed inside the vehicle body and having a receiving space;
a second receiving housing that forms the receiving space with the first receiving housing, and engaged with the first receiving housing to prevent a portion of the connection hose received in the receiving space in a zigzag from slipping out of place; and
a disengagement portion disposed on the opposite side of the connection coupling, and configured to apply an applied external pressure to the second receiving housing to disengage the second receiving housing from the first receiving housing so that the second receiving housing is separated from the first receiving housing.

9. The fire extinguishing device of claim 8, further comprising:
a pair of stopper protrusions formed on a pair of opposite surfaces that form the receiving space of the first receiving housing, spaced apart from each other; and
an interlock protrusion formed on a surface of the second receiving housing facing the pair of opposite surfaces, and inserted into the pair of stopper protrusions,
wherein, before the external pressure is applied to the connection coupling, the interlock protrusion is configured to be kept inserted into the pair of stopper protrusions to fix a relative position of the second receiving housing to the first receiving housing, and, upon the application of the external pressure to the connection coupling, the interlock protrusion is configured to be disengaged from the pair of stopper protrusions to separate the second receiving housing from the first receiving housing, and at the same time, the disengagement portion of the connection coupling is configured to be inserted between the pair of stopper protrusions to connect a connection pipe for injection of the fire extinguishing liquid to the connection coupling outside of the vehicle body.
